(19) United States
(12) Patent Application Publication
(10) Pub. No.: US 2022/0215345 A1
(43) Pub. Date: Jul. 7, 2022

(54) COMPUTERIZED SYSTEM AND METHOD FOR MULTI-CLASS, MULTI-LABEL CLASSIFICATION OF ELECTRONIC MESSAGES

(71) Applicant: VERIZON MEDIA INC., New York, NY (US)

(72) Inventors: Emerson AZARBAKHT, San Francisco, CA (US); Neeti NARAYAN, Sunnyvale, CA (US); Christopher C. LUVOGT, Fort Bragg, CA (US); Changsung KANG, San Jose, CA (US); Jean-Marc LANGLOIS, Alameda, CA (US); Umang PATEL, Sunnyvale, CA (US); Steven SHU, San Jose, CA (US)

(21) Appl. No.: 17/143,251

(22) Filed: Jan. 7, 2021

(51) Int. Cl. G06Q 10/10; G06N 3/08; G06N 3/04; G06F 16/35; G06F 16/335

(52) U.S. Cl. CPC G06Q 10/107; G06N 3/08; G06F 16/335; G06F 16/353; G06F 16/355; G06N 3/04

(57) ABSTRACT

Disclosed are systems and methods for improving interactions with and between computers in content providing and/or hosting systems supported by or configured with devices, servers and/or platforms. The disclosed systems and methods provide a novel framework that automatically labels and classifies incoming emails. The disclosed framework embodies a novel computerized taxonomy configured as a multi-tier, multi-label classification system. The first tier involves an offline grid classifier that has higher accuracy, and the second tier is an online classifier that classifies emails in real-time. Thus, the framework provides a novel approach to classifying messages based on a multi-tiered analysis, which is utilized for generating user profiles, delivering the messages, and the like.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to improving the performance of network-based computerized content hosting and providing devices, systems and/or platforms by modifying the capabilities and providing non-native functionality to such devices, systems and/or platforms through a novel and improved framework for automatically classifying electronic messages based on a multi-tiered analysis.

### BACKGROUND

In today's world, users typically have less time to read through the pool of daily emails they receive, and as a result, many of these users ignore, delete, or mark as spam such messages, and/or may even abandon their account altogether. Even with this knowledge, companies (e.g., brands) continue to send more messages, thereby overwhelming users and lowering engagement. This has created a vicious cycle which has reduced the resourcefulness of users' inboxes and the long-term value of mail users' data (for both Verizon Media® and third parties), while simultaneously reducing the effectiveness of direct-mail marketing.

More than 4 billion emails are delivered through Yahoo! Mail® every day, and over 95% of email traffic is machine generated, originating from bulk senders, such as, for example, ecommerce websites, financial institutions, newsletters, social networks, and the like. The current rate companies are sending emails to users, coupled with the inability for conventional mailboxes to handle and accurately process these messages, is causing this data to approach non-viability into a state that is draining the network resources of mail servers to process and deliver these messages.

### SUMMARY

This disclosure provides a novel framework that alleviates the current shortcomings in how messages are handled, classified, delivered and/or leveraged by servers and their associated messaging platforms. Among other benefits, as discussed herein, the disclosed classification framework enables the understanding of the kinds of emails users are receiving, reading and/or clicking links from, which unlocks an accurate signal that can be leveraged in building more accurate user profiles, which is a vital capability for recommendation models, as well as downstream systems that create highly personalized content, catered experiences, and more relevant ads.

However, classifying emails into fine-grained classes in a real-time fashion, or even in an offline data feed, is an open problem. That is, conventional systems and mechanisms for performing the required type and volume of classification either do not exist, or do not result in accurate and efficient results. Typical challenges include, but are not limited to, the sensitive nature of email data, data privacy, email traffic volume and latency.

The disclosed systems and methods provide a classification framework that is based on a novel taxonomy for automatically labeling messages. As will be evident from the discussion herein, such labeling can support the aforementioned use cases which can be further leveraged as the backbone for other horizontal pillars across the Verizon Media® ecosystem like Commerce, Next-Generation Experiences, and Super App experiences, for example.

According to some embodiments, the novel computerized taxonomy for classifying and labeling messages involves two (2) tiers of classifiers for multi-label email classification: (a) an offline grid classifier that has higher accuracy, and (b) an online classifier that classifies emails in real-time or substantially in real-time (e.g., as they are received). Thus, the offline and online approaches enable a multi-class label to be applied to a message, as illustrated in relation to FIG. 4, and discussed in more detail below in relation to FIGS. 4-6.

In accordance with one or more embodiments, the present disclosure provides computerized methods for a novel framework for automatically classifying electronic messages based on a multi-tiered analysis configuration of offline and online components. In accordance with one or more embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, messaging server, email server, ad server, content server and/or client device, and the like) cause at least one processor to perform a method for a novel and improved framework for automatically classifying electronic messages based on a multi-tiered analysis configuration of offline and online components.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with embodiments of the present disclosure;

FIG. 4 illustrates a non-limiting example network configuration in accordance with some embodiments of the present disclosure;

FIG. 5 is a block diagram illustrating an exemplary data flow in accordance with some embodiments of the present disclosure;

FIG. 6 is a block diagram illustrating an exemplary data flow in accordance with some embodiments of the present disclosure; and

FIG. 7 is a block diagram illustrating an exemplary data flow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

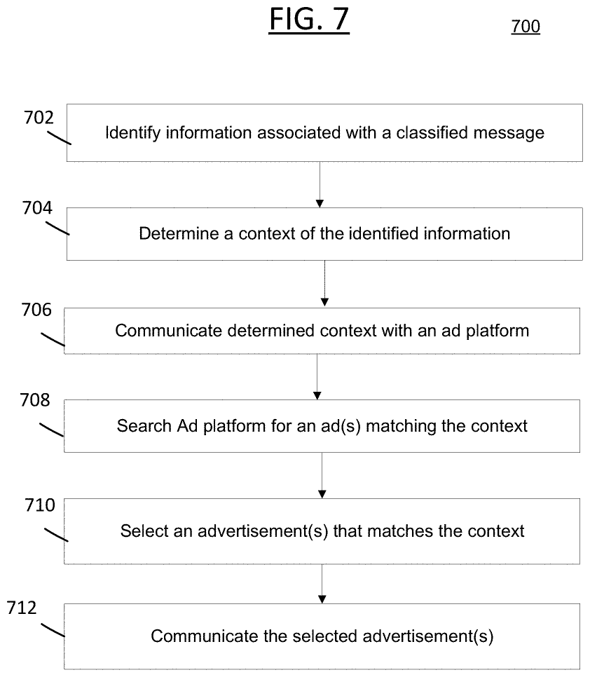

As discussed in more detail below at least in relation to FIG. 7, according to some embodiments, information associated with, derived from, or otherwise identified from, during or as a result of a message's classification, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

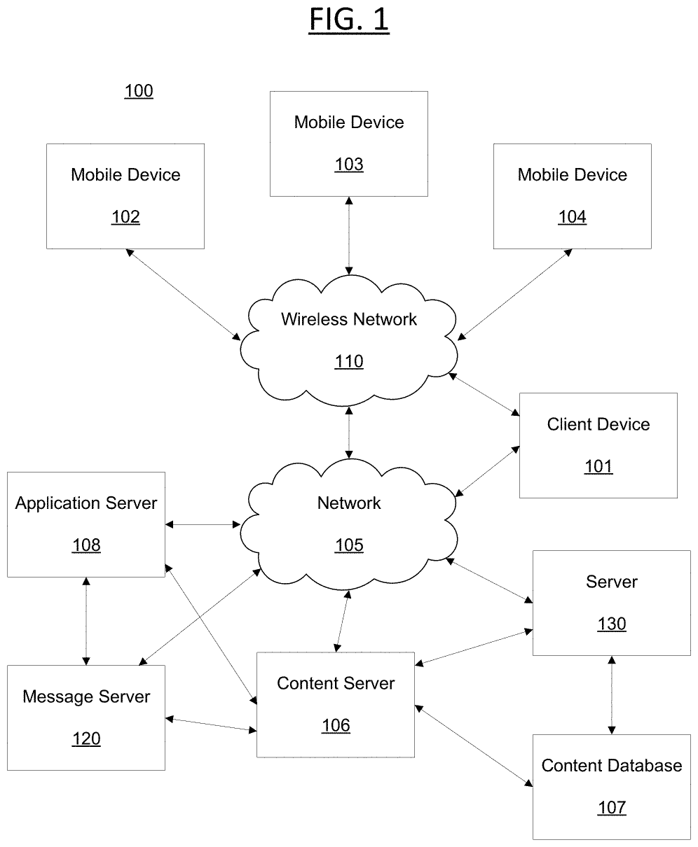

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, message server 120 and third party server 130.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. Content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like. Such services, for example the email services and email platform, can be provided via the message server 120.

Third party server 130 can comprise a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user data. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is, advertisers will pay higher advertising rates when they believe their ads are being placed in or along with highly relevant content that is being presented to users. Reductions in the time needed to quantify a high quality ad placement offers ad platforms competitive advantages. Thus, higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en-masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, gender, occupation, and the like) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In some embodiments, users are able to access services provided by servers 106, 108, 120 and/or 130. This may include in a non-limiting example, authentication servers, search servers, email servers, social networking services servers, SMS servers, IM servers, MMS servers, exchange servers, photo-sharing services servers, and travel services servers, via the network 105 using their various devices 101-104.

In some embodiments, applications, such as mail applications (e.g., Yahoo! Mail®, Gmail®, and the like), instant messaging applications, blog, photo or social networking applications (e.g., Facebook®, Twitter®, Instagram®, and the like), search applications (e.g., Yahoo! ® Search), and the like, can be hosted by the application server 108, message server 120, or content server 106 and the like.

Thus, the application server 108, for example, can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108, 120 and/or 130.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108 and/or 130 may be integrated into a single computing device, without departing from the scope of the present disclosure.

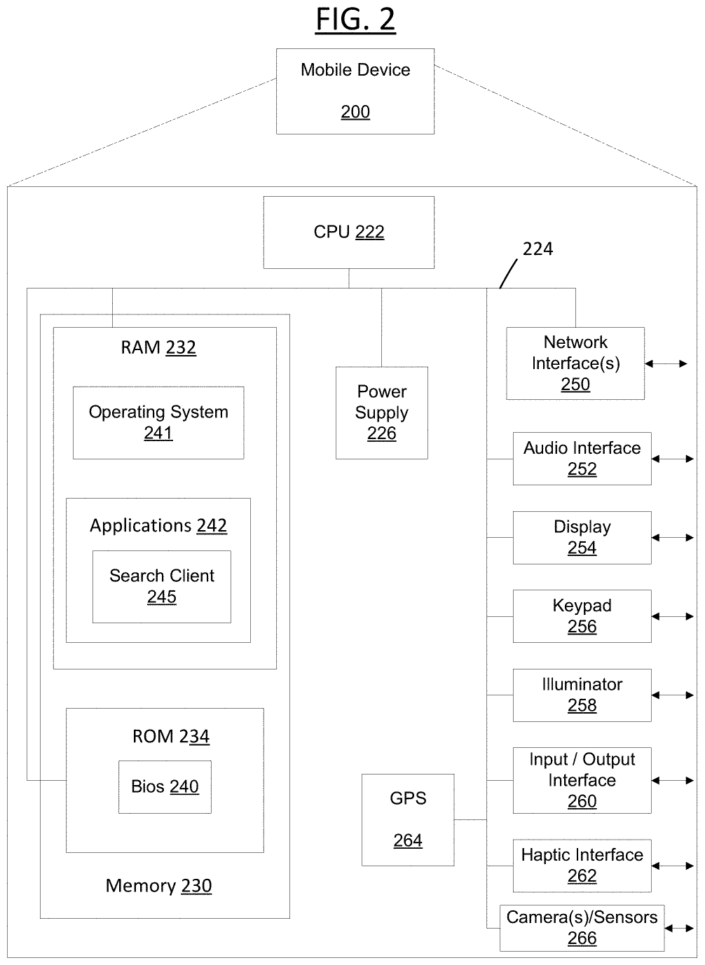

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to Client device 200.

Client device 200 may optionally communicate with a base station (not shown), or directly with another computing device. Network interface 250 is sometimes known as a transceiver, transceiving device, or network interface card (NIC).

Audio interface 252 is arranged to produce and receive audio signals such as the sound of a human voice. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. Illuminator 258 may provide a status indication and/or provide light.

Client device 200 also comprises input/output interface 260 for communicating with external. Input/output interface 260 can utilize one or more communication technologies, such as USB, infrared, Bluetooth™, or the like. Haptic interface 262 is arranged to provide tactile feedback to a user of the client device.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. In one embodiment, however, Client device may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200

Memory 230 further includes one or more data stores, which can be utilized by Client device 200 to store, among other things, applications 242 and/or other information or data. For example, data stores may be employed to store information that describes various capabilities of Client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 200.

Applications 242 may include computer executable instructions which, when executed by Client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

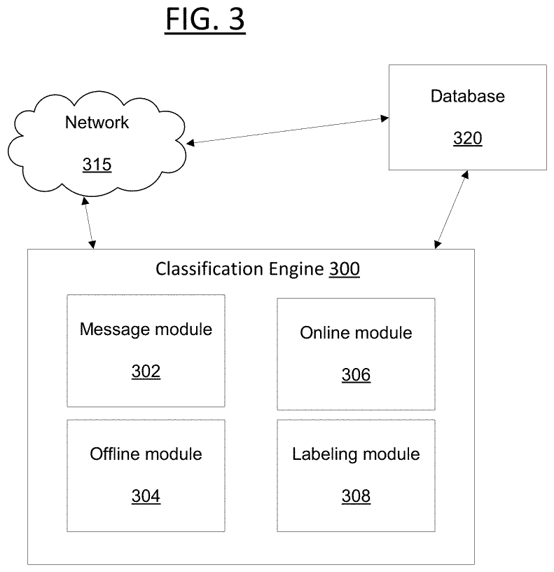

FIG. 3 is a block diagram illustrating the components for performing the systems and methods discussed herein. FIG. 3 includes classification engine 300, network 315 and database 320. The classification engine 300 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, classification engine 300 can be embodied as a stand-alone application that executes on a user device. In some embodiments, the classification engine 300 can function as an application installed on the user's device, and in some embodiments, such application can be a web-based application accessed by the user device over a network. In some embodiments, the classification engine 300 can be installed as an augmenting script, program or application (e.g., a plug-in or extension) to another application (e.g., Yahoo! Mail® and the like).

According to some embodiments, engine 300 is configured with a next generation mail classification schema, referred to as SPICE (Specialized Inbox Classification Engine). SPICE is the next generation of the current Yahoo! Mail® classification system: MAGMA (Machine Generated Mail Analysis).

MAGMA and its labels correspond to a set of 6 machine-generated classes (career, finance, shopping, social, travel and other) and a 7^{th} class for “personal” messages. At its latest or most current implementation, MAGMA applies deep-learning based Convolutional Neural Networks (CNNs) for automated classifications. This approach uses message subject and content as input, and is effective; however, it is still limited to the 6 of 7 class labels: there is not a separate online or lightweight model in MAGMA.

SPICE, embodied as engine 300, allows for finer-grained, multi-label classifications of emails within a given dimension (e.g., Topics=Career AND Finance), multiple-dimension classifications of emails (e.g., Type=Newsletter AND Topic=Career), and a more comprehensive schema that captures more information about emails, with dozens of possible labels.

According to some embodiments, engine 300 is comprised of multiple dimensions, each containing multiple labels, including “Topic”, “Type”, “Objective”, “Perceived Action” and “Method of sending”.

According to some embodiments, a “topic” label can include, but is not limited to: Apparel and Fashion, Automotive, Career, Education, Entertainment, Finance —deposit/withdrawal, Finance—investment, Finance—P2P, Finance—statement, Finance Other, Food and Dining, General Merch, Government and Politics, Health and Medicine, Hobbies and Crafts, Home and Garden, Law and Legal, Parenting and Families, Personal Care and Beauty, Personal Growth, Personals and Relationships, Pets and Animals, Real Estate, Science and Environment, Shipping and Freight, Social, Sports and Outdoors, Tech and Electronics, Transportation by vehicle for hire, Transportation Other, Travel—flight, Travel—lodging, Travel—package, Travel—rail, Travel—water, Travel Other, Other topic.

According to some embodiments, a “type” label can include, but is not limited to: Advertising (non-deal), Bill, Business Correspondence, Call to Action, Confirmation, Deal, Event—personalized, Event—general, Itinerary, Media (audio or visual), Newsletter and Media (text), Notification, Order, Personal Correspondence, Question or Answer, Receipt, Reservation, Shipment Procurement, Spam or Scam, Suggestion or Recommendation, Other.

According to some embodiments, an “objective” label can include, but is not limited to: Product shopping, Product rental, Services or experiences, Something else.

According to some embodiments, a “perceived action” label can include, but is not limited to: Add to calendar, Act in Mail Save in Mail, Reset Password, React online to message content (active), React offline to message content (active), Request more info/Do more research online, Request more info/Do more research offline, Save or use deal online, Save or use deal offline, View further content (passive), Do something else, Do nothing.

And, according to some embodiments, a “method of sending” label can include, but is not limited to: Human: Original, Human: Forward, Human: Reply, Human: Self-E, Machine: personalized, Machine: not personalized.

The database 320 can be any type of database or memory, and can be associated with a content server on a network (e.g., content server, a search server or application server) or a user's device (e.g., device 101-104 or device 200 from FIGS. 1-2). Database 320 comprises a dataset of data and metadata associated with local and/or network information related to users, services, applications, content and the like. Database 320 can also store information related to classes or labels, and/or the models (e.g., offline, online, logistic regression and convolutional neural network models, as discussed below), as discussed herein.

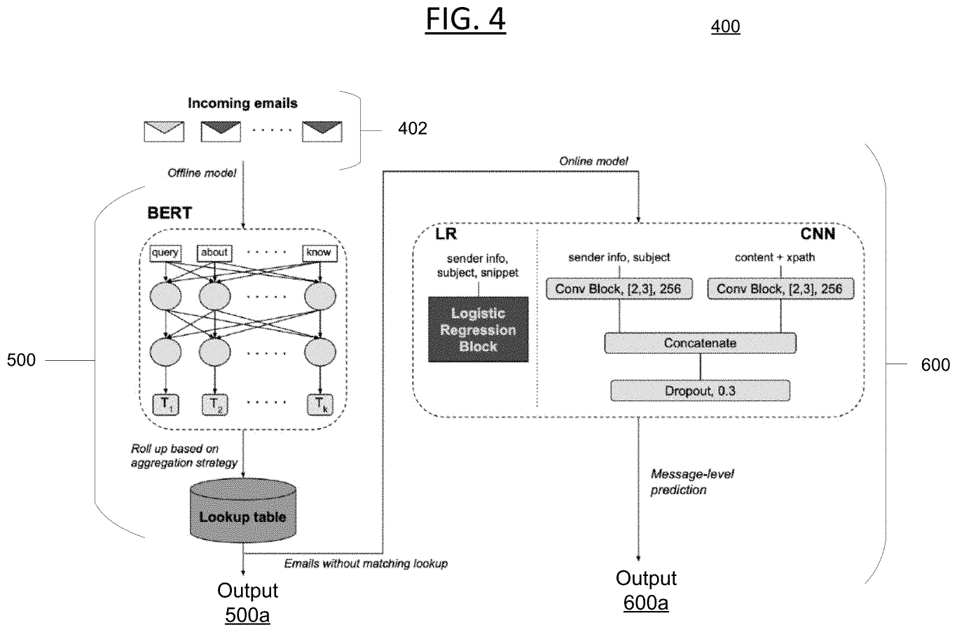

In some embodiments, such information can be stored and indexed in the database 320 independently and/or as a linked or associated dataset. An example of this is look-up table (LUT) illustrated in FIG. 4, as discussed below. As discussed above, it should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user attributes, user preferences or settings, user demographic information, user location information, user biographic information, and the like, or some combination thereof. In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with users, messages, images, videos, text, products, items and services from an assortment of media and/or service providers and/or platforms, and the like. Accordingly, any other type of known or to be known attribute or feature associated with a message and/or its transmission over a network, a user and/or content included therein, or some combination thereof, can be saved as part of the data/metadata in datastore 320.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the classification engine 300, and the database of stored resources 320. Indeed, as illustrated in FIG. 3, the classification engine 300 and database 320 can be directly connected by any known or to be known method of connecting and/or enabling communication between such devices and resources.

The principal processor, server, or combination of devices that comprise hardware programmed in accordance with the special purpose functions herein is referred to for convenience as classification engine 300, and includes message module 302, offline module 304, online module 306 and labeling module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

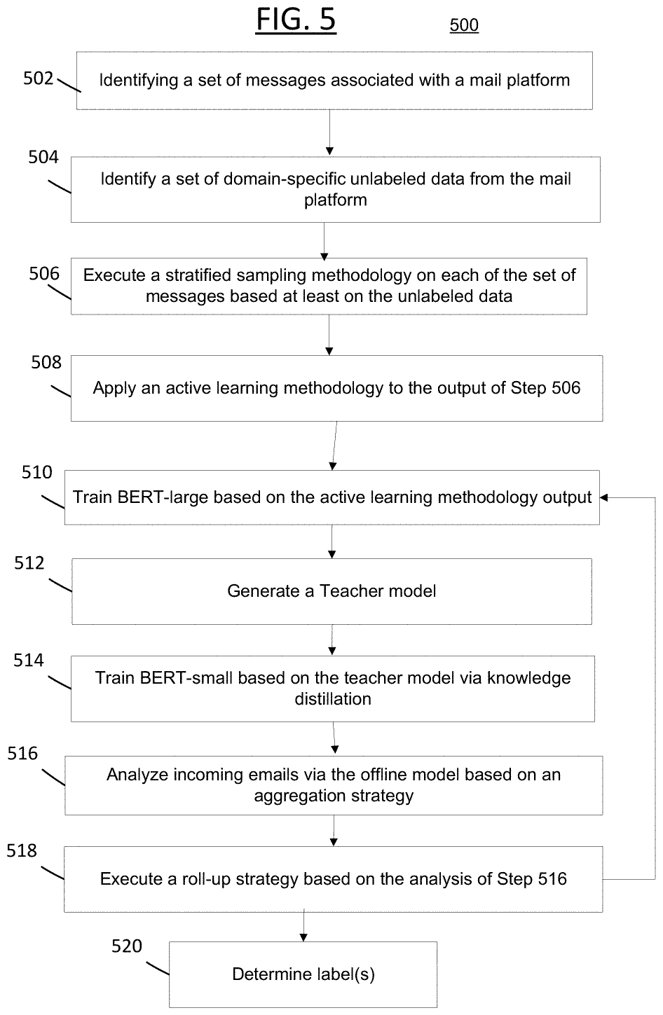

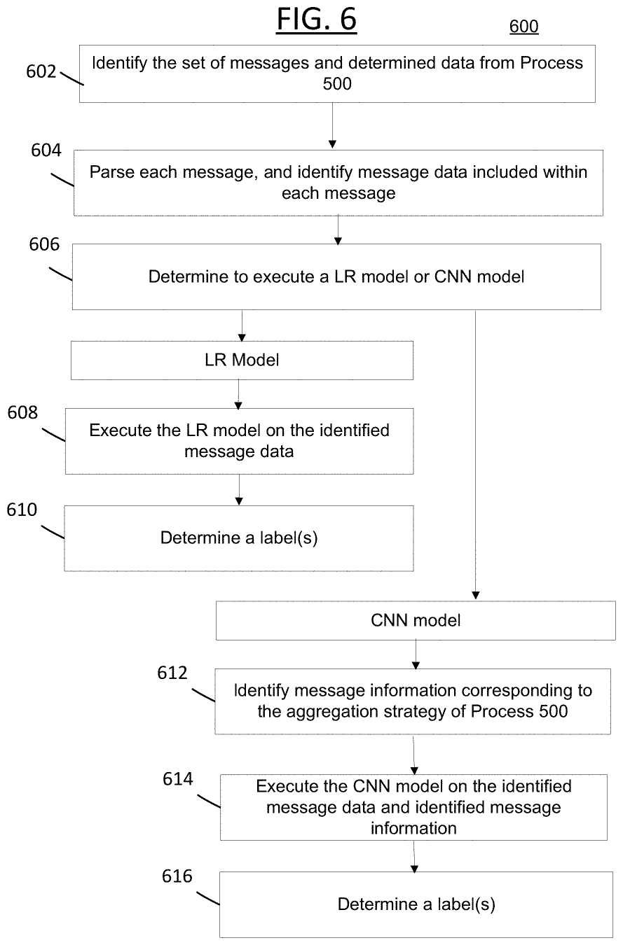

Turning to FIG. 4, a non-limiting example embodiment of a network configuration 400 corresponding to how engine 300 is implemented is displayed. The configuration 400 provides a pipeline of how one or more messages 402 are analyzed via the tiered approach disclosed herein. A first tier corresponding to offline Process 500 of FIG. 5, and a second tier corresponding to online Process 600 of FIG. 6.

According to some embodiments, the two-tiered approach of configuration 400 is based on a number of constraints that cause the devices, modules and processors operating within the disclosed pipeline of FIG. 4 to utilize neural network data rather than hand-engineered features, as in conventional systems.

In some embodiments, a first constraint is an industry standard commitment between service providers and clients to ensure near real-time delivery of emails, which leads to a 100 millisecond Service-Level Agreement (SLA) for fast classification of emails as they arrive and are delivered. According to some embodiments, a second constraint is the enormous size of inbound volume of Yahoo! Mail®, which is currently around 4 billion emails per day. In some embodiments, a third constraint is the finite computational resources available to perform classification inferences on all inbound email messages.

Based on these constraints, either individually or perceived as a combination of a current networking environment, engine 300 operates within configuration 400 of a two-tiered classification framework comprised of a grid (offline), non-real-time classification model (Process 500 of FIG. 5) and an online, real-time classification model (Process 600 of FIG. 6).

According to some embodiments, the classification configuration 400 utilizes a grid classifier, referred to as the Grid model. The Grid model executes a bidirectional encoder representations from transformations (BERT), which is configured to automatically learn discriminative and representative features from messages themselves without having to perform feature engineering to predict classes.

In some embodiments, the offline model (500) utilizes a version of BERT: BERT-large and BERT-small. BERT-large has slower inference time but higher accuracy, and is used to train BERT-small. BERT-small is a lightweight version of BERT-large, which enables quicker inference time but lower accuracy.

In some embodiments, as discussed below, the online model (600), which may only be implemented when the offline model (500) is unable to produce a label, utilizes a logistic regression (LR) model or a CNN model.

The tiered approach of these models (500 and/or 600) enables an accurate, multi-faceted classification which describes an incoming message 402 in a more complete manner, which can then be utilized for profile generation, message delivery, and/or other down-stream products, as discussed above.

According to some embodiments, upon receiving an incoming message 402, engine 300 applies the first tier to the message 402 via the offline analysis of Process 500 of FIG. 5. As illustrated, a message(s) 402 is received at a server and engine 300 executes the offline, BERT analysis. As a result, the output can be stored in a cache (e.g., the look-up table (LUT) illustrated in FIG. 4). The output (500a) can include information indicating how an analysis, labeling and/or both are performed with regard to a message or a cluster of messages (e.g., xcluster) (402). As discussed below, the data in the LUT can enable faster labeling/classification of subsequently received message. In some embodiments, as a result of this analysis, a set of labels 500a are determined, as discussed above and in more detail below.

Full details of the embodiments steps of Process 500 are discussed in detail below with reference to FIG. 5.

In some embodiments, at the conclusion of Process 500's analysis, engine 300 applies the second tier to the message 402 via the online analysis of Process 600 of FIG. 6. As illustrated in FIG. 4, the online model (600) executes a LR model or CNN model which results in an output (600a) of a message level prediction. The application of model (600) is performed when it is determined that model (500) is unable to produce an accurate label for a message.

Full details of the embodiments steps of Process 600 are discussed in detail below with reference to FIG. 6. As mentioned above, and in more detail below, the result of Process 600 includes a determination of labels 600a and a classification of the message, which can be utilized for downstream products, as discussed above.

Turning to FIG. 5, Process 500 details a non-limiting example embodiment of the offline analysis of incoming messages. Process 500 details the steps for configuring (or training) the offline model, and its application to incoming messages.

According to some embodiments of Process 500, Step 502 is performed by message module 302 of classification engine 300; Steps 504-512 and 516-518 are performed by offline module 304; Steps 514 are performed by offline module 304 and online module 306; and Step 520 is performed by labeling module 308.

Process 500 begins with Step 502 where a set of messages are identified. The set of messages can be associated with a particular mailbox, a set of mailboxes and/or a mail platform or across multiple platforms. The set of messages can be treated as training data (also referred to “training and testing data”, interchangeably).

In some embodiments, the training and testing data includes email messages sampled from a Human-Readable (HR) subset of messages retrieved from the Yahoo! Mail® platform. In some embodiments, the training data can constitute less than 0.1% of the email corpus. The size of the data set can be any value that provides an editorial scope to the context of the messages included therein—for example, the size of the training and testing data can range from, but is not limited to, 1K of messages to 27K of messages.

In some embodiments, the training messages identified in Step 502 are editorially labeled based on the labels discussed above in relation to FIG. 3—“Topic”, “Type”, “Objective”, “Perceived Action” and “Method of sending”.

In Step 504, a set of domain-specific unlabeled data from the mail platform is identified. This unlabeled data corresponds to message data, and/or any other type of data and/or metadata related to messages, users sending and/or receiving them and the content included therein. This data was unlabeled, in that it did not have any predetermined labeling with regard to the labeling of “Topic”, “Type”, “Objective”, “Perceived Action” and “Method of sending”.

In some embodiments, the unlabeled data is identified in relation to particular epochs (or time periods). The number of epochs, and/or the duration of each epoch can be dynamically determined and/or preset by engine 300 or an administrator. Thus, a plurality of sets of unlabeled data can be identified and, optionally aggregated, across a predetermined number of epochs.

In Step 506, based on the set of messages (from Step 502) and unlabeled data (from Step 504), engine 300 executes a stratified methodology. Step 506 involves taking as input the data from Steps 502 and 504 and executing a stratified sampling algorithm, technique or technology that accounts for values identifiable within the data from Step 502-504.

According to some embodiments, for example, sender identifiers and their activity are identifiable from the data of Steps 502-504. The stratified sampling techniques disclosed herein can be implemented by engine 300 to determine a data value that indicates a volume of the senders' monthly sent emails. Because there are millions of senders, stratifying directly by sender email address is not feasible or desirable. However, stratifying by N-ile (e.g., quartile, percentile, permille) based on volume of opened messages of the sender is both feasible and desirable. Since coarse-grained N-iles (low N) are not homogeneous (in terms of Topic, Type, Method), engine 300 stratifies based on sender permille (N=1000) in order to confirm N as large as possible.

In Step 508, an active learning algorithm, technique, mechanism or methodology is applied to the stratified sampling of Step 506. Such algorithms, techniques, mechanisms or methodologies can include, but are not limited to, machine learning, artificial intelligence, support vector machines, and the like, or other types of known or to be known learning technology.

According to some embodiments, the disclosed active learning approach combined the following three methods: 1) Least Confidence (LC), which selects the instance for which the model has the least confidence in its most likely label; 2) Margin Sampling, which selects the instance that has the smallest difference between the first and second most probable labels; and 3) Entropy Sampling, in which, an entropy formula is applied to each instance and the instance with the largest value is queried. In some embodiments, the active learning of the model based on Step 508 results in the reduction of noise or mislabeling in the datasets.

In Step 510, the BERT-large model is trained. This training is based on the output of the stratified sampling then active learning algorithms applied to the message data from Step 502 and unlabeled data from Step 504.

According to some embodiments, the offline model is a multiclass multi-label knowledge-distilled deep learning model for Natural Language Processing (NLP). As discussed above, the offline model is embodied as a BERT that is designed to pre-train and recognize deep bidirectional representations from unlabeled text by jointly conditioning on both left and right context in all layers. The training in Step 510, in some embodiments, involves the modification of the BERT code to make it multi-class multilabel, instead of multi-class single-label.

In Step 512, the pre-trained BERT-large model is fine-tuned with an additional output layer on the human-labeled data from the HR subset. This fine tuning enables the model to be configured as, or to create, the Teacher model for language inference. Thus, in some embodiments, the offline model executes NLP on the message data from Step 502, whereby as a result, the Teacher model is generated.

In Step 514, the Teacher model is used for training using a knowledge distillation process similar to the one discussed above, which produces a lightweight, faster version of the offline model (BERT-small).

According to some embodiments, the BERT Large model (340M parameters) is benchmarked to require 1500 ms inference time per email when run on a CPU (versus a GPU). This is not optimized for an online environment. Therefore, using a Teacher model based knowledge distillation process to train a BERT-small (29M parameters), a viable, optimized online model is produced which results in 350 ms inference time per email on CPU, i.e. 4X faster than BERT-large, with negligible loss in accuracy metrics.

In some embodiments, the training in Steps 510 and 514 results in an overall 81% precision at 71% recall (macro average of adjusted precision/recall for the 14 PM-prioritized classes).

Continuing with Process 500, after the training of BERT-small (the offline model) in Step 510, Process 500 proceeds to Step 516 where the offline model is applied to incoming messages. The application is based on an aggregation strategy that enables the offline model to analyze and “roll-up” messages for classification, as discussed below.

In some embodiments, due to the constraints related to incoming message volume, model complexity, and CPU-based grid resources, engine 300 may not be able to process incoming mail messages individually. Therefore, the offline model can implement an aggregation strategy that groups similar emails for classification, and assigns the predicted labels to all the emails in that group.

Thus, in some embodiments, Step 516 involves the parsing of incoming messages in order to determine if clusters can be generated, such that the offline model can be applied to a grouping of messages, thereby increasing the efficiency in its classification.

Clustering of messages is performed with regard to a lightweight virtual cluster, referenced as a “xcluster”, which can be stored in the LUT (of FIG. 4, as discussed above). Thus, in some embodiments, an xcluster is a collection of emails with a similar attribute (e.g., a similarity threshold satisfying layout), which are often sent in large batches by (usually) the same sender.

In some embodiments, the clustering can be performed by any known or to be known message analysis technique, algorithm, classifier or mechanism, including, but not limited to, computer vision, Bayesian network analysis, Hidden Markov Models, artificial neural network analysis, logical model and/or tree analysis, and the like.

In some embodiments, messages may be classified individually if they are not determined to be similar to other messages. In some embodiments, such messages may not be analyzed by the offline model and can be passed to the online model, as discussed below in relation to FIG. 6 and depicted in FIG. 4.

In some embodiments, the offline model is applied to a grouping of aggregated messages after a threshold amount of messages have been compiled within a grouping. In some embodiments, the offline model can be applied to a grouping after a determined time period, regardless of the number of messages in the grouping.

The determination of how to apply the offline model corresponds to Step 516 aggregation strategy, in that engine 300 determines in which manner to apply BERT-small to incoming messages.

Process 500 then proceeds to Step 518, where a “roll-up” strategy is applied. The roll-up strategy serves as a mitigation plan that allows the offline classification to function at higher abstraction level with minimal loss in model precision/recall. For example, the offline (grid pipeline) model can utilize a hybrid hierarchical based aggregation strategy. For example, a window of days (e.g., 21 days) that are based on how efficiently engine 300 can process the messages.

According to some embodiments, this strategy can involve, for example: 1) identifying the senders which show no variability in labels (after applying a class threshold and a 40% volume threshold). A sender is considered showing no variability if each of its xclusters from a sampling of classifications has the same labels. For such a sender, engine 300 can determine the average score of inference across the window of days (e.g., 21) and apply it to all emails from that sender for that day. The strategy further involves: 2) for the remaining senders, which do show variability, identifying xclusters which are showing no variability.

Thus, at the conclusion of Process 500, Step 520 results in the determination and application of a label(s) to a set of incoming messages (e.g., an xcluster). Such label(s), as discussed above, can be multi-dimensional with regard to the categories of classes discussed above. As mentioned above in relation to FIGS. 3-4, this data can be stored in the LUT, and can include, but is not limited to, the model data related to how an xcluster was labeled, the determined label(s), the message data of the xcluster, and the like, or some combination thereof. This data can be utilized for updating or forming new xclusters for usage in analyzing subsequently received incoming messages.

Process 500 also includes a feedback loop from Step 520 to Step 510. This feedback loop indicates that Process 500 is recursive such that the data produced for labeling an xcluster (or message) can be used to further training and updating of the Teacher model and BERT-small.

Turning to FIG. 6, Process 600 details a non-limiting example embodiment of the online analysis of incoming messages. Such analysis, as discussed above, in some embodiments, is performed when it is determined that the offline model cannot produce a label for a message. For example, when a message does not correspond, at least to a threshold degree, to an existing xcluster. According to some embodiments of Process 600, Step 602 is performed by message module 302 and offline module 304 of classification engine 300; Steps 604-608 and 612-614 are performed by online module 306; and Steps 610 and 616 are performed by labeling module 308.

Process 600 begins with Step 602 where the data from Process 500 is passed from the offline model (tier 1 of Process 500) to the second tier embodied by the online model. In some embodiments, this data can include the message data from the incoming messages. In some embodiments, this data can be annotated to or identified as a tag (or other form of metadata) to the message for processing by the online model.

In Step 604, the messages can be parsed and the message data included therein can be identified. In some embodiments, this data can be provided as part of the data received in Step 602. In some embodiments, the analysis and identification of message data can be performed by any known or to be known message analysis technique, algorithm, classifier or mechanism, including, but not limited to, computer vision, Bayesian network analysis, Hidden Markov Models, artificial neural network analysis, logical model and/or tree analysis, and the like.

In Step 606, engine 300, determines whether to execute a logistic regression (LR) model or a CNN model, as discussed above and illustrated in FIG. 4.

According to some embodiments, the LR model (Steps 608-610) is utilized for messages that do not have a matching sender or xcluster. This depends on the type of aggregation strategy applied in Steps 516-518 of Process 500. Thus, if incoming messages are analyzed and determined not to match an xcluster that was analyzed via the offline aggregation strategy, as discussed above, then such messages are analyzed via the online, LR model.

According to some embodiments, the vocabulary for LR model is a top character tri-gram that is based on a number of occurrences in a large volume of email data. Sender email, sender name, message subject and snippet data can be utilized as input to the model (which can be derived from Step 604's parsing and identification).

According to some embodiments, the LR model can combine these inputs at the raw feature level, which can induce the usage of hyperparameters for training/updating the LR model, which ensures a threshold satisfying performance on a validation set. The LR model can utilize a sigmoid cross entropy as a loss function for each Topic node (e.g., 27 nodes). The LR model enables the overall loss to be minimized and to be is equal to the mean of each individual loss.

Thus, turning to Step 608, the LR model analyzes the messages, determines its data, combines them at the raw feature level, and outputs, in Step 610, a determined label(s) based on the message(s) parameters. Such, label(s), as discussed above can be multi-dimensional.

Turning back to Step 606, if incoming messages are analyzed and determined to match an xcluster that was analyzed via the offline aggregation strategy, as discussed above, then such messages are analyzed via the online, CNN model (Steps 612-616).

According to some embodiments, the CNN model is configured for implementation using sender email, sender name, message subject (which constitutes a short sequence) and content with xpath (which constitutes a long sequence). In some embodiments, WordPiece tokenization (or another type of segmentation) can be applied to the message(s) on the input. In some embodiments, an embedding dimension of 128, filter sizes, 256 filters, short sequence length of 250 and long sequence length of 500 can be leveraged for the CNN application.

In some embodiments, the online, CNN model can be trained for a predetermined number of epochs (e.g., 2) with a learning rate of 0.0001, that minimizes the loss and batch size.

In Step 612, message information corresponding to the aggregation strategy (from Step 516) is identified. As discussed above, this involves the xcluster data, which can be derived or identified from the data from Step 602 (or the LUT).

In Step 614, the CNN model is executed, which results in the labeling of the messages. Step 616. Such labeling can be multi-dimensional, as discussed above.

As a result of Process 600, in Steps 610 or 616, a multi class label is determined for a message. The label is similar to the one produced above with reference to Process 500 of FIG.

By way of non-limiting example, with reference to FIGS. 4-6, the offline model (Process 500) or online model (Process 600) can output a multi-dimensional label. For example, either model can label a message with the multi-class label “Travel, Event—personalized; product rental; add to calendar”, which can be stored and used for downstream products.

The labeled data for a message(s) can be used for updating, populating and/or creating a user profile for a user. This data can also be used for delivering a message to a mailbox, managing the recipient's mailbox, for recommendation system and monetization systems, as discussed above.

For example, if a message corresponds to ski rental for an upcoming family vacation, it can be labeled, via Processes 500 and 600, as “Travel, Event—personalized; product rental; add to calendar”. This can cause labels to be displayed in the recipients inbox to indicate such multi-tiered labeling. In some embodiments, this data can be used to recommend additional content or third party content, an example of which is discussed below in relation to FIG. 7.

FIG. 7 is a work flow process 700 for serving or providing related digital media content based on the information associated with a message, as discussed above in relation to FIGS. 4-6. In some embodiments, the provided content can be associated with or comprising advertisements (e.g., digital advertisement content). Such information can be referred to as “message information” for reference purposes only.

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In Step 702, message information is identified. This information can be derived, determined, based on or otherwise identified from the steps of Processes 500 and/or 600, as discussed above. For example, the message information can be based on a topic determined from either process, a classification of the message, and the like, or some combination thereof.

For purposes of this disclosure, Process 700 will refer to single incoming message (or single xcluster); however, it should not be construed as limiting, as any number of messages, over any amount of time for any number of users, can form such basis, without departing from the scope of the present disclosure.

In Step 704, a context is determined based on the identified message information. This context forms a basis for serving content related to the message information.

For example, as discussed above in relation to FIGS. 4-6, a message is received and classified, and its classification indicates that it corresponds to “food and dining.” Therefore, this context can be leveraged in order to identify digital content related to coupons, services, deals or offers for restaurants, food delivery, and the like, either at physical stores and/or online.

In some embodiments, the identification of the context from Step 704 can occur before, during and/or after the analysis detailed above with respect to Processes 500-600, or it can be a separate process altogether, or some combination thereof.

In Step 706, the determined context is communicated (or shared) with a content providing platform comprising a server and database (e.g., content server 106 and content database 107, and/or advertisement server 130 and ad database). Upon receipt of the context, the server performs (e.g., is caused to perform as per instructions received from the device executing the engine 300) a search for a relevant digital content within the associated database. The search for the content is based at least on the identified context.

In Step 708, the server searches the database for a digital content item(s) that matches the identified context. In Step 710, a content item is selected (or retrieved) based on the results of Step 708.

In some embodiments, the selected content item can be modified to conform to attributes or capabilities of the message, or page, interface, platform, application or method upon which the message will be drafted, sent and/or displayed, and/or to the application and/or device for which it will be displayed.

In some embodiments, the selected content item is shared or communicated via the application the user is utilizing to draft, view, render and/or interact with a message, text, media, content or object item. Step 712.

In some embodiments, the selected content item is sent directly to a user computing device for display on the device and/or within the UI displayed on the device's display (e.g., inbox, as a message within the inbox, or as part of the original message from which the selected content item was based).

In some embodiments, the selected content item is displayed within a portion of the interface or within an overlaying or pop-up interface associated with a rendering interface displayed on the device.

In some embodiments, the selected content item can be displayed as part of a coupon/ad clipping, coupon/ad recommendation and/or coupon/ad summarization interface.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, over a network, by a computing device, a message from a sender;
parsing, by the computing device, the message, and identifying message data;
analyzing, by the computing device, based on an aggregation strategy, the message data;
determining, by the computing device, based on the aggregation strategy analysis, whether the message data corresponds to an xcluster of messages;
when the determination indicates that the message data corresponds to a xcluster of messages,
adding said message to the xcluster;
applying a grid classifier to the xcluster of messages, said grid classifier application comprising determining and applying a multi-dimensional label; and
when the determination indicates that the message data does not correspond to a xcluster of messages,
further analyzing the message data;
determining a type of online classifier based on the further analysis of the message data;
applying the determined type of online classifier to the message, said online classifier application comprising determining and applying another multi-dimensional label.

2. The method of claim 1, wherein the type of online classifier comprises a logistic regression (LR) model.

3. The method of claim 1, wherein said type of online classifier comprises a Convolutional Neural Network (CNN) model, wherein said application of the online classifier is further based on information associated with the aggregation strategy.

4. The method of claim 1, wherein each of the multi-dimensional labels comprise information indicating at least one of a topic, type, objective, perceived action and method of sending.

5. The method of claim 1, further comprising:
generating, for at least a recipient of the message, a user profile based on the message data of the message and at least one of the determined labels.

6. The method of claim 1, wherein said message is delivered to an inbox based on at least one of the determined labels.

7. The method of claim 1, further comprising storing, in an associated database, information related to the determined labels.

8. The method of claim 1, wherein said aggregation strategy corresponds to a type attribute of a message used for creating an xcluster of messages.

9. The method of claim 1, wherein said grid classifier is applied offline, wherein said grid classifier executes a version of bidirectional encoder representations from transformations (BERT).

10. The method of claim 9, wherein said offline classifier is trained based on the grid classifier.

11. The method of claim 1, further comprising:
identifying a set of messages associated with a message platform;
identifying a set of unlabeled data associated with the message platform;
sampling the set messages based at least in part on the unlabeled data;
applying an active learning algorithm to the sampled messages; and
training the grid classifier based on the application of the active learning algorithm.

12. The method of claim 1, further comprising:
requesting, over the network, third party digital content based at least on one of the determined labels;
receiving, over the network, the third party digital content; and
communicating, over the network, the third party digital content to a recipient of the message along with the message.

13. A non-transitory computer-readable storage medium tangibly encoded with computer-executable instructions, that when executed by a processor associated with a computing device, performs a method comprising:
receiving, over a network, by the computing device, a message from a sender;
parsing, by the computing device, the message, and identifying message data;
analyzing, by the computing device, based on an aggregation strategy, the message data;
determining, by the computing device, based on the aggregation strategy analysis, whether the message data corresponds to an xcluster of messages;
when the determination indicates that the message data corresponds to a xcluster of messages,
adding said message to the xcluster;
applying a grid classifier to the xcluster of messages, said grid classifier application comprising determining and applying a multi-dimensional label; and
when the determination indicates that the message data does not correspond to a xcluster of messages,
further analyzing the message data;
determining a type of online classifier based on the further analysis of the message data;
applying the determined type of online classifier to the message, said online classifier application comprising determining and applying another multi-dimensional label.

14. The non-transitory computer-readable storage medium of claim 13, wherein the type of online classifier comprises a logistic regression (LR) model.

15. The non-transitory computer-readable storage medium of claim 13, wherein said type of online classifier comprises a Convolutional Neural Network (CNN) model, wherein said application of the online classifier is further based on information associated with the aggregation strategy.

16. The non-transitory computer-readable storage medium of claim 13, wherein each of the multi-dimensional labels comprise information indicating at least one of a topic, type, objective, perceived action and method of sending.

17. The non-transitory computer-readable storage medium of claim 13, wherein said grid classifier is applied offline, wherein said grid classifier executes a version of bidirectional encoder representations from transformations (BERT), wherein said offline classifier is trained based on the grid classifier.

18. A computing device comprising:
a processor configured to:
receive, over a network, a message from a sender;
parse the message, and identify message data;
analyze, based on an aggregation strategy, the message data;
determine, based on the aggregation strategy analysis, whether the message data corresponds to an xcluster of messages;
when the determination indicates that the message data corresponds to a xcluster of messages,
add said message to the xcluster;
apply a grid classifier to the xcluster of messages, said grid classifier application comprising determining and applying a multi-dimensional label; and
when the determination indicates that the message data does not correspond to a xcluster of messages,
further analyze the message data;
determine a type of online classifier based on the further analysis of the message data;
apply the determined type of online classifier to the message, said online classifier application comprising determining and applying another multi-dimensional label.

19. The computing device of claim 18, wherein the type of online classifier comprises a logistic regression (LR) model.

20. The computing device of claim 18, wherein said type of online classifier comprises a Convolutional Neural Network (CNN) model, wherein said application of the online classifier is further based on information associated with the aggregation strategy.
